(19) United States
(12) Patent Application Publication
(10) Pub. No.: US 2016/0372217 A1
(43) Pub. Date: Dec. 22, 2016

(54) Nuclear Reactor Containment Vessel and Nuclear Reactor

(71) Applicant: Hitachi, Ltd., Tokyo (JP)

(72) Inventors: Akinori TAMURA, Tokyo (JP); Kazuaki KITO, Tokyo (JP)

(21) Appl. No.: 14/590,363

(22) Filed: Jan. 6, 2015

(30) Foreign Application Priority Data
Jan. 22, 2014 (JP) 2014-009082

(51) Int. Cl. G21C 15/18

(52) U.S. Cl. CPC G21C 15/18; G21Y 2002/201; G21Y 2004/30

(57) ABSTRACT

The invention relates to a nuclear power generation plant, and a nuclear reactor containment vessel includes a containment vessel covering a nuclear reactor pressure vessel, an air-cooled heat exchanger which is installed outside the containment vessel and performs heat exchange between steam in the containment vessel and air outside the containment vessel, and a square column-shaped air flow path provided vertically above the air-cooled heat exchanger.

### BACKGROUND OF THE INVENTION

1. Technical Field

The present invention relates to a nuclear reactor containment vessel of a nuclear power generation plant.

2. Description of Related Art

Patent Literature 1 (JP-A-5-256977) discloses a technique relating to an emergency gas processing equipment of a nuclear power station. Specifically, a hollow structure covering a nuclear reactor containment vessel is provided, a side suction port and an upper discharge port are disposed in the hollow structure, and a filter is attached to the upper discharge port. At the time of an accident, heated air is generated by decay heat conducted to the hollow structure from the nuclear reactor containment vessel, and air flow is generated by the heated air. The heated air is discharged to the outside of the hollow structure by the air flow.

Since the driving force due to buoyancy is very small as compared with a case where a dynamic device such as a pump is used, it is required to reduce pressure loss of air flow as much as possible. However, in the emergency gas processing equipment disclosed in Patent Literature 1, the sectional area of an air flow path of an annulus part is reduced toward an upper part of the containment vessel. Thus, the air flow speed increases, and the acceleration loss due to air acceleration increases. Accordingly, there is a problem that the cooling performance of the containment vessel is reduced since the acceleration loss due to the air acceleration increases.

### SUMMARY

An object of the invention is to improve the cooling performance of a containment vessel.

According to the invention, an air flow path is provided vertically above an air-cooled heat exchanger.

According to the invention, the cooling performance of the containment vessel is improved.

### BRIEF DESCRIPTION OF THE DRAWINGS

FIG. 1 is a structural view of a nuclear reactor containment vessel cooling equipment of embodiment 1.

FIG. 2 is a structural view of a nuclear reactor containment vessel cooling equipment of a comparative example.

FIG. 3 is a view of the nuclear reactor containment vessel cooling equipment of the embodiment 1 when seen from above.

FIG. 4 is a structural view of a nuclear reactor containment vessel cooling equipment of embodiment 2.

FIG. 5 is a view of the nuclear reactor containment vessel cooling equipment of the embodiment 2 when seen from above.

FIG. 6 is a structural view of a nuclear reactor containment vessel cooling equipment of embodiment 3.

FIG. 7 is a view of the nuclear reactor containment vessel cooling equipment of the embodiment 3 when seen from above.

### DESCRIPTION OF EXEMPLARY EMBODIMENTS

Hereinafter, embodiments will be described with reference to the drawings.

### Embodiment 1

In order to facilitate understanding of this embodiment, a comparative example of a nuclear reactor containment vessel cooling equipment of a nuclear power generation plant will be described.

FIG. 2 is a structural view of the nuclear reactor containment vessel cooling equipment of the nuclear power generation plant according to the comparative example. An emergency gas processing equipment 1 includes a containment vessel 2, a hollow structure 3 covering the containment vessel, a side suction port 4 and an upper discharge port 5 provided in the hollow structure, a filter 6 attached to the upper discharge port 5, and an annulus part 7 which is a gap between the containment vessel and the hollow structure. Incidentally, the containment vessel 2 of the comparative example is made of steel. Besides, a nuclear reactor building 11 is provided on the lower side of the side suction port 4.

If an accident occurs in which steam is discharged from a nuclear reactor pressure vessel 10 into the nuclear reactor containment vessel 2 and the temperature of the nuclear reactor containment vessel abnormally rises, the heat in the containment vessel is transmitted through the containment vessel 2 to air 8 in the annulus part 7. A specific gravity difference occurs between the heated air and the atmosphere, and buoyancy is generated. The heated air is discharged to the atmosphere through the upper discharge port 5, and new air flows into the annulus part 7 through the side suction port 4. That is, cooling by natural ventilation can be achieved without using a dynamic device. At this time, driving force F (Pa) obtained when the air 8 in the annulus part 7 rises by the buoyancy can be calculated by the following expression.

F=ΔμgH (1)

Where, Δρ(kg/m³) is a density difference between the heated air and the atmosphere, g(m/s²) is a gravity acceleration, and H(m) is an effective height. If the containment vessel 2 is a heat transfer surface, the air 8 of the annulus part flowing in from the side suction port 4 is gradually heated by the whole surface of the containment vessel. Thus, the effective height H is about ½ of a height difference between the side suction port 4 and the upper discharge port 5.

Besides, as shown in FIG. 2, when an air-cooled heat exchanger 9 is installed at a lower part of the annulus part 7, most of the heat in the containment vessel is transmitted to the air of the annulus part 7 through the air-cooled heat exchanger 9. The air-cooled heat exchanger 9 is connected to an inner heat exchanger provided inside the containment vessel 2 through a connection pipe passing through the containment vessel 2. High-temperature steam generated in the containment vessel 2 performs heat exchange with the inner heat exchanger and performs heat exchange with a heat medium of the inner heat exchanger, and supplies heat to the air-cooled heat exchanger 9 through the connection pipe.

Since the air flowing in from the side inflow port 4 is immediately heated by the air-cooled heat exchanger 9, the effective height H in the expression (1) is a height difference between the air-cooled heat exchanger 9 and the upper discharge port 5, and the driving force F of the air 8 of the annulus part due to the buoyancy can be more improved. Dimensionless heat transfer coefficient Nu(−) representing the cooling performance of air cooling is obtained by the following Dittus-Boelter expression.

Nu=0.023Re^{0.8}Pr^{0.4} (2)

Where, Re(−) is Raynolds number and is proportional to a flow speed in an identical system. Pr(−) is Prandtl number and is a physical property value determined by the kind of working fluid. Since the cooling performance of the air cooling increases in proportion to 0.8 power of the flow speed from the expression (2), if the flow driving force F is improved by installing the air-cooled heat exchanger 9 and the flow speed is increased, the cooling performance of the equipment can be more improved.

When the air-cooled heat exchanger 9 is used in order to increase the driving force for causing the air of the annulus part 7 to rise, since an air flow path sectional area of the annulus part is reduced toward an upper part of the containment vessel, the acceleration loss increases. Besides, for maintenance of the air-cooled heat exchanger, a take-out port and a take-out mechanism of the air-cooled heat exchanger 9 are required to be provided in the vicinity of the side suction port 4. Thus, there is a problem that the structure becomes complicated and the cost increases. Since an air-cooling heat transfer coefficient is smaller by several hundred times than a boiling-condensation heat transfer coefficient, the air-cooled heat exchanger 9 is large as compared with a general heat exchanger using boiling-condensation heat transfer of steam. Accordingly, it is difficult to provide the take-out port of the large heat exchanger in the hollow structure 3.

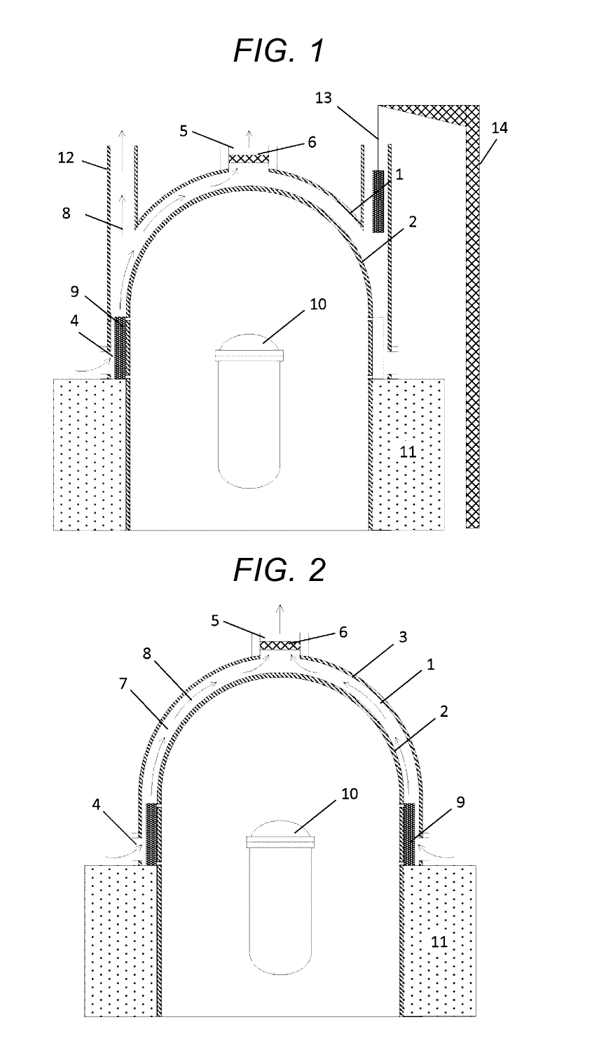

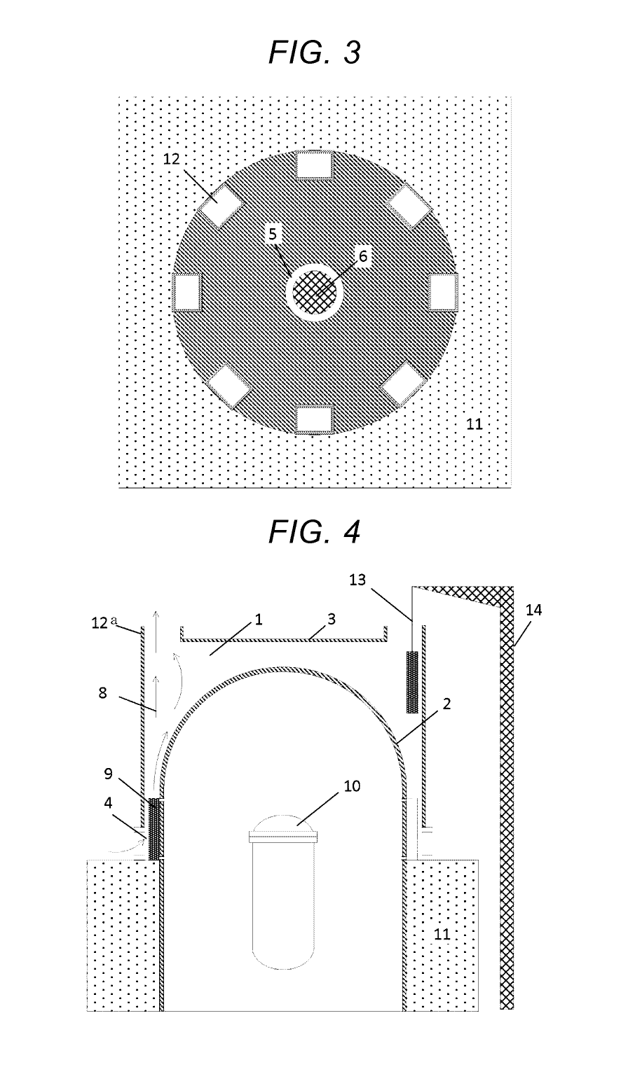

FIG. 1 is a structural view of a nuclear reactor containment vessel cooling equipment of this embodiment. In the structural view of FIG. 1, a description of portions common to those of FIG. 2 will be omitted. Besides, the left half of FIG. 1 shows a state of a normal operation, and the right half thereof shows a state at the time of maintenance of an air-cooled heat exchanger 9. In this embodiment, a square column-shaped bypass air flow path 12 is provided. The bypass air flow path 12 is installed vertically above the air-cooled heat exchanger 9. FIG. 3 is a view of the nuclear reactor containment vessel cooling equipment of this embodiment when seen from above. A flow path sectional area of the bypass air flow path is set to be larger than at least a sectional area of the air-cooled heat exchanger when seen from above. The atmosphere flowing in from a side suction port 4 is heated by the air-cooled heat exchanger 9, and rises in an annulus part 8 by buoyancy. Since the heated air is divided into a flow flowing toward an upper discharge port 5 and a flow flowing through the bypass air flow path 12, the air flow path sectional area is obtained by adding the bypass air flow path sectional area to the air flow path sectional area of the annulus part toward the upper discharge port 5. Accordingly, in this embodiment, the air flow path sectional area is not reduced also in the upper part of the containment vessel, and air acceleration is not generated. Thus, the acceleration loss can be suppressed, and the containment vessel cooling performance can be improved. The minimum sectional area of the bypass air flow path required to suppress the air acceleration is 64 m² when the amount of removed heat is 10 MW. Incidentally, a filter may be attached to an outlet of the bypass air flow path similarly to the upper discharge port 5.

Since the sectional area of the bypass air flow path 12 is larger than the sectional area of the air-cooled heat exchanger when seen from above, at the time of maintenance of the air-cooled heat exchanger 9, the bypass air flow path 12 can be used as a removing port when the air-cooled heat exchanger 9 is lifted by a cable 13 attached to a tip of a crane 14. At the time of maintenance of the air-cooled heat exchanger 9, the air-cooled heat exchanger 9 and a connection pipe of the containment vessel are separated, and the heat exchanger 9 is lifted by the crane 14. The air-cooled heat exchanger 9 is taken out to the outside through the bypass air flow path 12. After the maintenance, the air-cooled heat exchanger 9 is installed at a specified position of the annulus part by using the crane 14. Since the bypass air flow path 12 is used as the removing port of the air-cooled heat exchanger 9, a take-out port and a take-out mechanism in the vicinity of the side suction port 4 become unnecessary, and the cost of installation of the air-cooled heat exchanger 9 can be reduced.

### Embodiment 2

FIG. 4 is a structural view of a nuclear reactor containment vessel cooling equipment of this embodiment. In the structural view of FIG. 4, a description of portions common to those of FIG. 1 will be omitted. An air flow path 12a is installed vertically above an air-cooled heat exchanger 9. Although the hollow structure 3 of FIG. 1 is formed along the curved surface, a hollow structure 3 of this embodiment is formed into a cylindrical shape. Since a containment vessel 2 is formed into a semi-circular shape, an interval (annulus part) between the hollow structure 3 and the containment vessel 2 is wide at a ceiling peripheral part as compared with a ceiling center part.

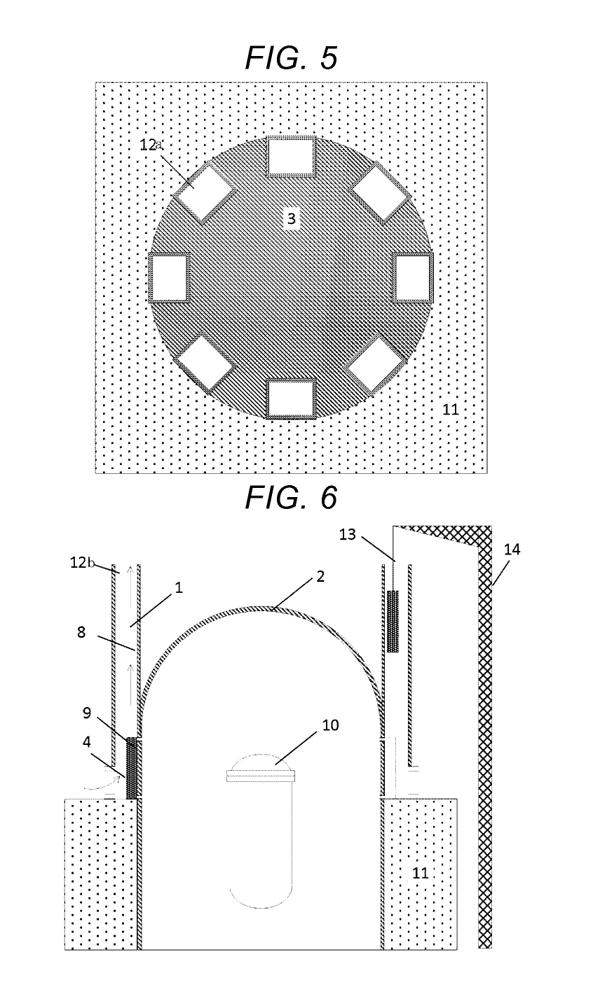

FIG. 5 is a view of the nuclear reactor containment vessel cooling equipment of this embodiment when seen from above. A flow path sectional area of the air flow path 12a is set to be larger than at least a sectional area of the air-cooled heat exchanger when seen from above. The atmosphere flowing in from a side suction port 4 is heated by the air-cooled heat exchanger 9, and rises in the annulus part 8 by buoyancy. Since the heated air passes through the air flow path 12a and flows out to the outside, the acceleration of air can be suppressed by adjusting the sectional areas of the air flow path 12a and the annulus part. Thus, acceleration loss can be reduced and the containment vessel cooling performance can be improved. Especially, in FIG. 5, since the interval (annulus part) between the hollow structure 3 and the containment vessel 2 is wide as compared with that in FIG. 1, the acceleration of air can be more reduced. The minimum sectional area of the air flow path 12a required to suppress the air acceleration is 128 m² when the amount of removed heat is 10 MW. In this embodiment, since an air discharge port at an upper part of the hollow structure is unnecessary, the cost of the cooling equipment can be reduced. Besides, since the annulus part can be used as a take-out port of the air-cooled heat exchanger, the maintainability of the air-cooled heat exchanger is improved, and the cost of installation of the air-cooled heat exchanger can be reduced.

At the time of maintenance of the air-cooled heat exchanger 9, the air flow path 12a can be used as a removing port when the air-cooled heat exchanger 9 is lifted by a cable 13 attached to a tip of a crane 14. At the time of maintenance of the air-cooled heat exchanger 9, the air-cooled heat exchanger 9 and a connection pipe of the containment vessel are separated, and the air-cooled heat exchanger 9 is lifted by the crane 14. The air-cooled heat exchanger 9 is taken out to the outside through the air flow path 12a. After the maintenance, the air-cooled heat exchanger 9 is installed at a specified position of the annulus part by using the crane 14. Since the air flow path 12a is used as the removing port of the air-cooled heat exchanger 9, a take-out port and a take-out mechanism in the vicinity of a side suction port 4 are unnecessary, and the cost of installation of the air-cooled heat exchanger 9 can be reduced.

### Embodiment 3

FIG. 6 is a structural view of a nuclear reactor containment vessel cooling equipment of this embodiment. In the structural view of FIG. 6, a description of portions common to those of FIG. 1 will be omitted. In the nuclear reactor containment vessel cooling equipment of this embodiment, a hollow structure 3 covering an outer periphery of a containment vessel 2 is not provided. Besides, when the nuclear reactor containment vessel cooling equipment is seen from above, eight air flow paths 12b are installed at equal intervals in the periphery of the containment vessel 2. The square column-shaped air flow paths 12b are installed vertically above air-cooled heat exchangers 9, and one of the air flow paths 12b corresponds to one of the air-cooled heat exchangers 9.

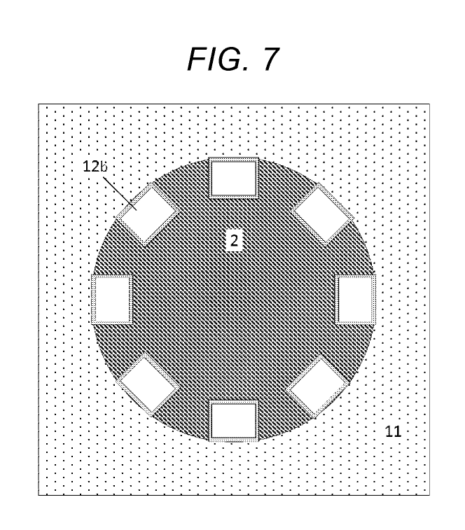

FIG. 7 is a view of the nuclear reactor containment vessel cooling equipment of this embodiment when seen from above. A flow path sectional area of the air flow path 12b is set to be larger than at least a sectional area of the air-cooled heat exchanger when seen from above. The atmosphere flowing in from a side suction port 4 is heated by the air-cooled heat exchanger 9, and rises in the air flow path 12b by buoyancy. The acceleration of air can be suppressed by adjusting the sectional area of the air flow path 12b, and the acceleration loss can be reduced and the containment vessel cooling performance can be improved. The minimum sectional area of the air flow path required to suppress the air acceleration is 128 m² when the amount of removed heat is 10 MW. In this embodiment, since a hollow structure and an air discharge port of an upper part of the hollow structure are not required, the cost of the cooling equipment can be reduced.

At the time of maintenance of the air-cooled heat exchanger 9, the air flow path 12b can be used as a removing port when the air-cooled heat exchanger 9 is lifted by a cable 13 attached to a tip of a crane 14. At the time of maintenance of the air-cooled heat exchanger 9, the air-cooled heat exchanger 9 and a connection pipe of the containment vessel are separated, and the heat exchanger 9 is lifted by the crane 14. The air-cooled heat exchanger 9 is taken out to the outside through the air flow path 12b. After the maintenance, the air-cooled heat exchanger 9 is installed at a specified position of the air flow path by using the crane 14. Since the air flow path 12b is used as the removing port of the air-cooled heat exchanger 9, a take-out port and a take-out mechanism in the vicinity of the side suction port 4 are unnecessary, and the cost of installation of the air-cooled heat exchanger 9 can be reduced.

What is claimed is:

1. A nuclear reactor containment vessel comprising:
a containment vessel covering a nuclear reactor pressure vessel;
air-cooled heat exchanger which is installed outside the containment vessel and performs heat exchange between steam in the containment vessel and air outside the containment vessel; and
a column-shaped air flow path provided vertically above the air-cooled heat exchanger.

2. The nuclear reactor containment vessel according to claim 1, wherein a sectional area of the air flow path is larger than a sectional area of the air-cooled heat exchanger when seen from above.

3. The nuclear reactor containment vessel according to claim 1, wherein a hollow structure covering the containment vessel has a cylindrical shape.

4. The nuclear reactor containment vessel according to claim 1, wherein one of a plurality of the air flow paths corresponds to one of a plurality of the air-cooled heat exchangers.

5. A nuclear reactor comprising:
a containment vessel covering a nuclear reactor pressure vessel;
an air-cooled heat exchanger which is installed outside the containment vessel and performs heat exchange between steam in the containment vessel and air outside the containment vessel; and
a column-shaped air flow path provided vertically above the air-cooled heat exchanger.
